(19) United States
(12) Patent Application Publication
(10) Pub. No.: US 2009/0297412 A1
(43) Pub. Date: Dec. 3, 2009

(54) Solid/liquid reaction process and vessel incorporating buoyant covers

(75) Inventor: Dale Harrison, Western Australia (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SONS OF GWALIA LTD, WEST PERTH (AU)

(21) Appl. No.: 11/658,488

(22) PCT Filed: Jul. 22, 2005
(86) PCT No.: PCT/AU2005/001085

§ 371 Date: Jul. 30, 2009

(30) Foreign Application Priority Data
Jul. 23, 2004 (AU) 2004904057

(51) Int. Cl. C22B 3/04; B01J 19/02

(52) U.S. Cl. 423/31; 422/240

(57) ABSTRACT

Disclosed is a solid/liquid reaction process comprising the steps of:
a) forming a slurry of a solid and a solution containing a species (SA) reactive with the solid and convertible to a species in the gas phase (SG);
b) conducting a reaction between the solid and the species SA in a slurry in a vessel; and
c) controlling a process condition of the slurry to minimise reactive conversion of species SA to species SG.

Reactive conversion of species SA to species SG in the vessel is minimised by the placement of laminar slurry cover buoyant with respect to the slurry in the vessel. A process of particular importance is the process of cyanidation of gold ores in which reactive conversion of aqueous cyanide (CN_{aq}⁻) to HCN (g) is a particular problem. A vessel (1, 2, 3) and leach circuit for conducting the solid/liquid process is also disclosed.

This invention relates to a solid/liquid reaction process and vessel incorporating a buoyant cover for enhancing process efficiency and economics. The invention may be applicable in hydrometallurgical and chemical processes including leaching processes.

In any chemical process, economics dictate that the costs of production of a valuable commodity be reduced to the maximum extent. Leaching processes involve consumption of leaching reagents which may have significant cost. Recycling and recovery processes are often used to obtain reagents from waste streams or emissions to reduce these costs. However, recycling and recovery processes may also require expenditure of capital cost. For example, certain chemical processes may result in gas evolution or the evolution of volatile species from a liquid reacting mixture, evolution processes which are contrasted from the evaporation of water. These emissions may be captured and subjected to scrubbing and other processes, often with the intent of recovering useful reagent for reuse in the chemical process. Capital costs associated with gas capture, cleaning and treatment may be substantial.

Special difficulties arise, moreover, where emissions or evolved gases are toxic. In that case, hazardous concentrations of the emissions or evolved gases must not be allowed to build up in a gas space above the level of the liquid reacting mixture.

One example only of such a process is cyanidation of gold ores. Such a process involves leaching of gold ores in a alkaline cyanide solution. The desired leaching species is CN_{aq}⁻. However, that species is convertible to HCN_{aq} or HCN_{g}, a volatile and highly toxic species wasteful of cyanide. The TLV for HCN_{g} is 10 ppm and concentrations are ideally to be maintained at lower levels. Build-up of HCN_{g} levels to higher concentrations may have rapidly lethal or fatal effects. Other analogous chemical processes to cyanidation also exist.

Conventionally, however, cyanidation operations are conducted in vessels open to, and exposed to, the atmosphere with HCN_{g} levels being controlled by careful regulation of leach conditions such as pH in the leach. This may be

6. The process according to claim 3 wherein placement of said laminar slurry cover is conducted under cold climate conditions and low pressure climatic conditions.

7. The process according to claim 1 wherein said vessel is a tank with circular cross-section and said slurry cover is divided into segments of said circular cross-section.

8. The process according to claim 3 wherein said cyanidation reaction is conducted in a plurality of vessels, at least one of the vessels being fitted with said slurry cover.

9. The process according to any one of claims 1 to 4 wherein said slurry cover covers the near totality of a surface area of said vessel.

10. The process according to any one of claims 1 to 3 wherein said slurry cover covers the totality of a surface area of said vessel.

11. The process according to claim 9 wherein said cover is UV and abrasion resistant.

12. The process according to claim 4 wherein said solution contains hypersaline water.

13. The process according to claim 4 wherein a thickness of said cover is selected with reference to degree of agitation of said slurry in use.

14. A vessel when used in the process according to any one of the preceding claims 1 to 10.

15. A leach circuit including at least one vessel as claimed in claim 14. effective but HCN_{g} levels may rise to noticeable levels with process variations, under cold climatic conditions and low pressure climatic conditions. Highly saline or hypersaline waters used in the leach, as discovered by the Applicant, also make pH and HCN_{g} control more difficult. As well as creating a safety hazard, formation of HCN—a species that plays no part in gold dissolution—represents a loss of leaching reagent to the system. The CN-HCN conversion reaction is therefore a negative for process economics. Other leaching or chemical processes may involve equilibria between “useful” and “non-reactive” species that are potentially hazardous and detrimental to process economics.

One embodiment of the present invention provides a solid/liquid reaction process comprising the steps of:
a) forming a slurry of a solid and a solution containing a species (SA) reactive with the solid and convertible to a species in the gas phase (SG);
b) conducting a reaction between said solid and said species SA in said slurry in a vessel; and
c) controlling a process condition of said slurry to minimise reactive conversion of said species SA to said species SG;

wherein reactive conversion of species SA to said species SG in said vessel is minimised by placement of a laminar slurry cover buoyant with respect to said slurry in said vessel.

Either species SA and SG may be inorganic and, in particular, SA may be an inorganic species suitable for leaching processes, particularly hydrometallurgical processes.

In the case of the leaching process of gold cyanidation, species SA is the aqueous cyanide ion, reactive to the gold ore and also reactive with other metals and chemical species present in the ore to form cyanide complexes or other byproducts, such side complexation being undesirable. Species SG is the species HCN, a volatile, toxic and unwanted species likely formed in accordance with the conversion reaction:

CN_{aq}⁻→HCN_{aq}→HCN_{g} (1)

the rate and extent of completion of which is to be minimised. The rate and extent of completion of the reaction (1) is dependent, in part, on available, exposed surface area of slurry in the vessel. The cover reduces this surface area and the conversion of aqueous cyanide to HCN_{g}.

Control over pH condition of the slurry at least is also exercised to minimise such reactive conversion. Such control is achieved by adding a pH modifying agent. In cyanidation, an alkaline reagent—such as lime—is used for the purpose.

The buoyant cover may have a number of characteristics. It is of material substantially impermeable to the gas phase species SG. The specific gravity (s.g) of the cover is less than that of the slurry, noting that the slurry s.g is a function of pulp density or the proportion of solids in the slurry. The laminar cover is, desirably, of thickness selected for degree of agitation of the vessel. That is, the process will likely be conducted in an agitated vessel, likely a mechanically agitated vessel. A thin sheet, even if buoyant, would be destroyed or at least damaged to the point of unusability in an agitated vessel, particularly as used in gold cyanidation. A thin sheet might also “balloon” or inflate in an aerated system, where gases evolve from the slurry, causing undesirable build-up of gaseous species. This, as far as possible, is to be avoided. A thicker cover will avoid the problem. The buoyant cover is of material inert to the chemical process. The material is selected to suit the slurry/solutions that it may contact. Polymeric foams, such as polyurethane and polystyrene, are suitable for cyanidation processes.

The cover contacts the slurry in manner to minimise and prevent gas evolution in quantity. In the case of HCN, buildup in concentrations above 10 ppm is to be avoided. Therefore, pockets in, and inflatability of, the cover by evolved gases are to be avoided. Laminar covers covering at least a portion of the vessel cross-sectional area are employed, avoiding gas evolution to any appreciable extent. If the vessel, for example, a tank, is of circular cross section, the cover may be formed or divided, in any desired manner, into corresponding portions to segments of that cross-section. Segments covering a central zone of the tank surface may be surrounded by an annulus of further cover segments. The segments or sections may optionally be connected by means such as velcro strips, staples or tape or left unattached to each other. A segmental or sectional construction also facilitates ready repair and replacement. The segments or sections may be keyed together. Where polymer foam layers, such as polyurethane or polystyrene foam layers or boards, are used as the cover, keys may take the form of foam cut-outs that co-operate with one or more sections to connect them together. Such cover sections may be retrofitted to tank(s).

The cover or cover sections, trimmed to suit, may be retained in the vessel or tank by the tank walls and other location or securing devices, such as pins connected to cover segments and vessel superstructure, to ensure that the cover remains in contact with a slurry/solution surface regardless of the level of the slurry/solution in the vessel or tank or the degree of expected agitation or aeration of the slurry/solution. The location devices may be designed to accommodate variation in the tank level encountered under expected process conditions. In addition, vortex motion in an agitated tank could cause a cover or cover section to rotate. As this is undesirable, locating pins or other securing means may be arranged to prevent such rotation.

In a further embodiment, the invention provides a vessel when used in the above described process including:
a) a volume for containing a liquid such as a liquid reacting mixture of species including a species SA and volatile species SG formed by reactive conversion from species SA; and
b) a cover for said volume of liquid

wherein the cover is buoyant with respect to, and in contact with, the liquid. The cover is of material substantially impermeable and inert to said volatile species SG and is, desirably, of thickness selected with reference to, or in accordance with, degree of agitation of the liquid in use. The vessel may be used in a process in accordance with the above embodiment of the invention.

The vessel, when used for a chemical or hydrometallurgical process—such as—but not limited to—gold cyanidation—is likely agitated, potentially with a powerful mechanical agitator. The cover must remain in position performing its function of minimising conversion of reactive species SA to gaseous or volatile species SG despite the agitation of the vessel. A degree of flexibility in the cover to maintain contact with the slurry or solution may be required to achieve this. Accordingly, having the cover in a number of sections is desirable as may connection of the individual cover sections with a flexible means such as Velcro strips, staples or tape.

The cover may be employed in one or a plurality of tanks or vessels used to conduct the chemical or hydrometallurgical process. For example, if the process involves multiple vessels or tanks, in series, advantage in terms of reduced consumption of species SA and loss as volatile or gaseous species SG, the cover may be used with benefit in at least one vessel or tank. Benefit may be achieved even if only the first tank in the series is fitted with the cover. It is a relatively straightforward and inexpensive matter to fit the remaining tanks of the series with buoyant covers. It follows that retrofitting to existing plants is feasible.

As the cover will likely be exposed to climatic conditions including sunlight as well as abrasive slurries, the cover may be of U.V and abrasion resistant material or may incorporate additives to reduce U.V and abrasion degradation. The cover may be sprayed with materials including compositions and films that are U.V and/or abrasion resistant, such as SOLAR-GARD.

Advantages accrue through reduced consumption, and higher effective concentration of, chemical reagents, including leaching reagents, source of species SA such as cyanide; and pH modifying reagents, such as lime, as pH control may be facilitated in accordance with the process. pH control in hypersaline waters may be facilitated allowing better approach to optimal alkaline pH range for cyanidation. Lower ambient concentrations of potentially toxic gaseous species that represent a loss of valuable reagents from the process may result. Improved process kinetics and, possibly, recoveries may also be achieved with potential capital cost benefits in new plants.

The invention will now be described by a preferred non-limiting embodiment, the description being made referent to the accompanying drawings in which:

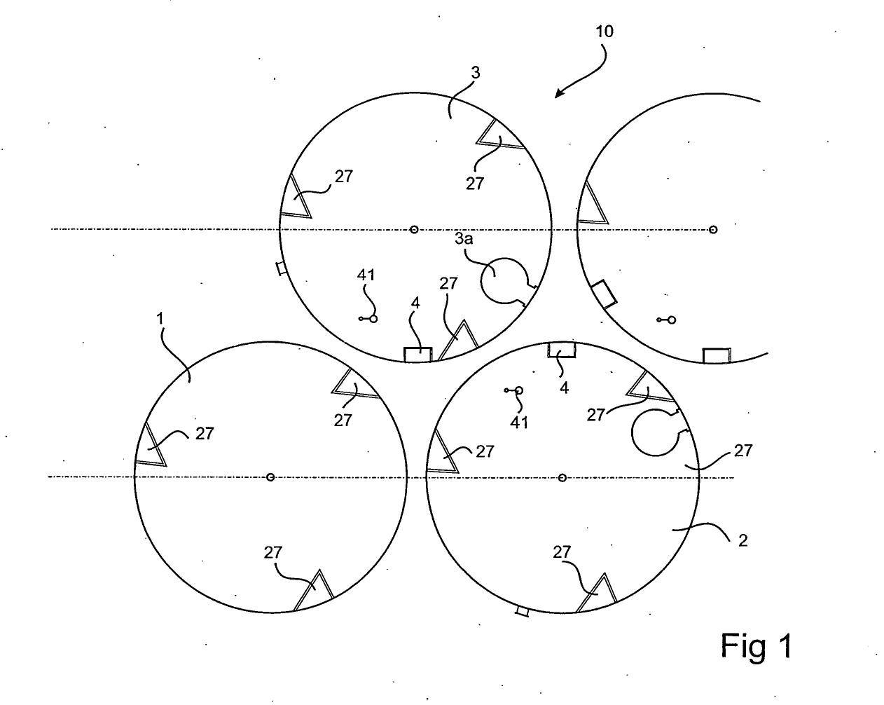

FIG. 1 is a plan view of a series of tanks employed in a process conducted in accordance with one embodiment of the present invention;

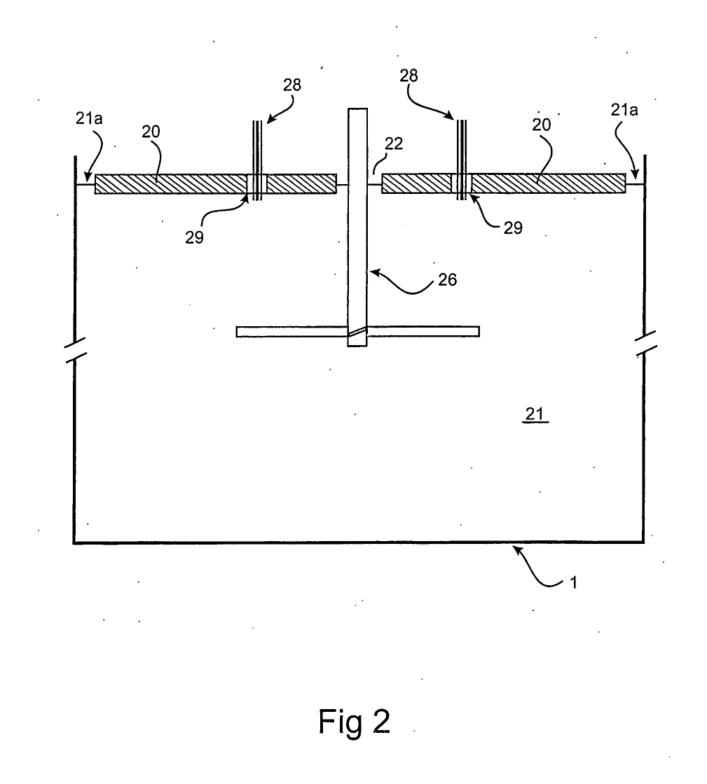

FIG. 2 is a side view of a tank included within FIG. 1 showing location of a buoyant cover.

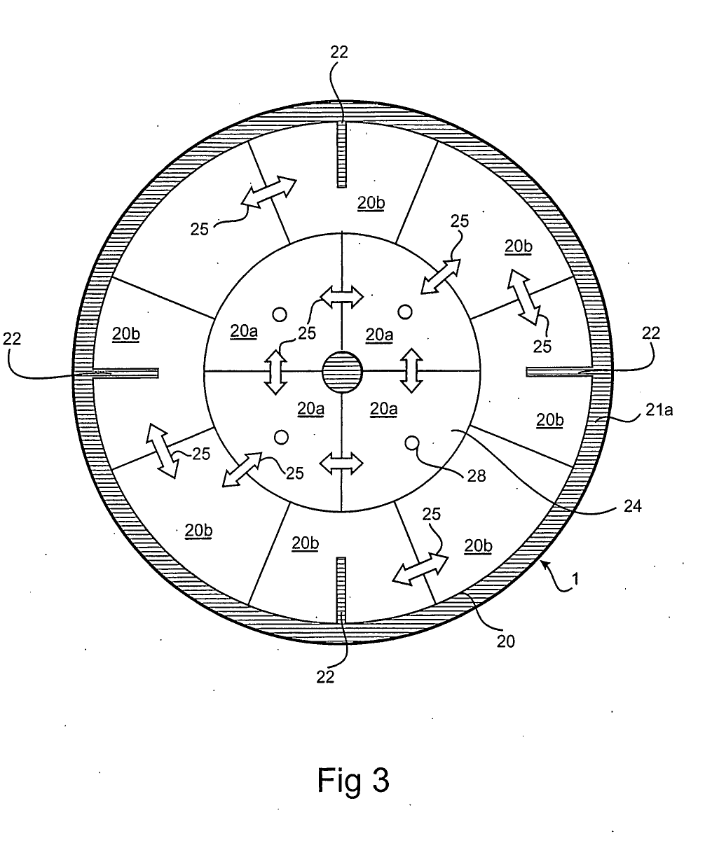

FIG. 3 is a plan view of a tank included within FIG. 1 and showing the buoyant cover as comprised of a number of segments.

In a preferred embodiment, a gold containing ore is subjected to alkaline cyanide leaching, the reactive CN_{aq}⁻species causing dissolution of the ore in accordance with accepted cyanidation practice at atmospheric pressure. The cyanidation process involves formation of a slurry of gold ore and aqueous cyanide solution. The aqueous cyanide level is controlled at desired levels to dissolve gold values by control over the cyanide addition and pH. Nevertheless, a certain proportion of aqueous cyanide will convert to and report as HCN both in solution and, because HCN is a volatile species, in the gas phase. The cyanidation process proceeds in three tanks 1 to 3 forming a leach circuit 10 of the cyanidation plant as shown in FIG. 1. Tanks 1 to 3 are fitted with baffles 27 to ensure adequate mixing of the slurry and downcorners 4 for delivering slurry to each tank. Carbon transfer pumps 41 are shown fitted in tanks 2 and 3.

As the water used to make up a leaching cyanide solution in the plant has a high salt content, that is hypersaline, limited control over pH may be attainable. Therefore, a significant portion of the cyanide added to the circuit may be converted to HCN in solution. Some of this HCN is evolved from the surface 21a of the slurry 21 when tanks 1 to 3 are open to the atmosphere and represents a loss of cyanide from the leach circuit 10. The rate of loss of HCN from the slurry may be related to the initial cyanide addition rate, slurry pH, water salinity and the available surface area for the HCN to be released among other factors.

Cover 20, made of a polymeric foam layer, such as closed cell polyurethane foam or polystyrene foam, was accordingly installed, in accordance with an embodiment of the invention, in tank 1 as shown in FIG. 2. The cover 20 is laminar, buoyant and in direct contact with slurry 21 noting its level 21a within the tank. Buoyancy of cover 20 is achieved due to manufacture of the cover 20 from a material, or composite of materials, together having a specific gravity less than that of slurry 21. The specific gravity of slurry 21 varies with the content of solids in that slurry or pulp density. For ease of illustration, FIG. 2 shows the cover 20 as formed from a single piece of polymer foam material or board.

It may be noted that cover 20 has a cut-out portion 22 to accommodate an agitator 26. Agitator 26 is a high powered mechanical agitator of conventional type such as a turbine agitator of known power rating. It induces a high degree of turbulence in tank 1 to maintain ore solids in suspension and promote the gold cyanidation reaction.

The thickness of laminar cover 20 is selected, initially by trial and error, to resist damage due to expected degree of agitation in tank 1 by the agitator 26 while maintaining an effective cover reducing conversion of aqueous cyanide to HCN. In addition, as cover 20 is exposed to abrasion by particles within slurry 21 it may be sprayed. or covered with an abrasion resistant composition. Cover 20 will also be exposed to sunlight, and ultraviolet (UV) radiation as tank 1 is in the open. Accordingly, it may be sprayed with an ultra-violet light resistant composition or film, such as available under the trade mark SOLAR-GUARD, to resist U.V degradation.

In an alternative embodiment, as shown in FIG. 3, cover 20 is made up of a number of segments 20a and 20b which are cut, or otherwise formed from polymer foam to cover the totality or near totality of the surface area of tank 1 barring an annular opening 21a at the tank 1 periphery and at the agitator shaft 26 through which little HCN escapes. Four segments 20a cover a central zone 24 of the tank 1. These segments 20a are surrounded by an annular zone covered by further segments 20b. As tank 1 includes baffles 27, the cover segments 20a and 20b are cut with slots 33 to allow the baffles 27 to be accommodated. If covers are fitted to other tanks, including baffles, downcorners, sampling points and, in the case of tank 3, carbon screen 3a, carbon transfer pumps 41, they may likewise be cut or otherwise formed to accommodate these elements.

Division of cover 20 into segments 20a and 20b, facilitates installation and removal, and allows a degree of flexibility in the cover which reduces risk of damage and better accommodates turbulence induced by agitator 26 within the tank 1 without allowing gas pockets containing HCN to form. In addition, repair and replacement of cover segments 20a and 20b will be facilitated and less expensive than if an entire cover for the tank 1 required to be repaired or replaced.

The cover segments 20a and 20b are secured to minimise or prevent their rotation within. To control such movement of cover segments 20a, locating pins 28 are fitted to tank superstructure (not shown) and passed through holes 29 in the central cover segments 20a. Cover segments 20a may slide along the locating pins 28 in accordance with changes in tank 1 level to maintain direct contact with the slurry 21. The locating pins 28 are of length to accommodate expected level variation in the tank. The locating pins 28 are of material, such as steel or plastic, inert to the slurry 21. Segments 20a and 20b are further connected, in this preferred embodiment, by foam cut-out keys 25, keying segments together, to prevent rotation. Additional connection with Velcro, staples or tape may occur, if desired.

Table 1 below presents a composite of 24 day trial data immediately before the installation of cover 20 and post-installation.

A significant change in ore feed 4-5 days occurred after cover 20 had been fitted to tank 1. This change of ore feed required the plant to run at a lower pulp density (more water per tonne of ore) and slightly higher cyanide concentrations.

Initial observations of the raw data indicated a 14% reduction in the cyanide required to achieve the desired slurry cyanide concentration. There was lower conversion of aqueous cyanide to volatile HCN reflecting a lower rate of conversion and, consequently, rate constant of conversion between aqueous cyanide and HCN species. On normalisation of the data to allow for the average pulp density prior to change in ore feed, a 20% reduction in cyanide consumption was achieved for the period of the trial.

Atmospheric HCN readings above tank 1 were noticeably reduced (61%) with the cover 20 in place. Tank 2, not fitted with a cover during the trial, showed an elevation in HCN levels after cover segments 20a and 20b were fitted to tank 1, reflecting the higher cyanide (and thus HCN) concentration of slurry entering tank 2.

Further, it was noted that a significant increase in pH and the maximum pH attained in slurry 21 was achievable once the cover segments 20a and 20b had been fitted. This, as well as being beneficial to cyanidation efficiency, allowed a 1% reduction in lime addition, used to control pH levels, to be achieved. Over the period of the trial, the pH was maintained significantly higher than previously possible for hypersaline water used in the leach, with slightly less lime being used. This was beneficial to the process. Gold recoveries (about 2% or better) and process kinetics may also be enhanced with further benefits.

TABLE 1
Trial Reagent Data

| | Without | With | |
|---|---|---|---|
| | covers | covers | % reduction |
| Avge CN consumption kg/t | 0.56 | 0.48 | 14% |
| Avge % solids | 46% | 44% | |
| Norm consumption kg/t | 0.56 | 0.45 | 20% |
| Average pH | 8.69 | 8.94 | |
| Avg Lime Consumption - Norm | 3.87 | 3.84 | 1% |
| Tk 1 HCN emission ppm | 0.70 | 0.27 | 61% |
| Tk 2 HCN emission ppm | 0.77 | 1.06 | −37% |

Normalised results take into account the change in pulp density

No additional engineering or structural modifications are required to fit the system and no additional monitoring/instrumentation are required to monitor the container once the system is in place. Ease of installation and removal allows maintenance to be conducted in accordance with existing maintenance and safety schedules.

Modifications and variations to the process and vessel of the invention may be envisaged by the skilled reader of this disclosure. For example, the cover segments may formed and connected in any desired manner and applied to chemical or hydrometallurgical processes other than gold cyanidation. Such modifications and variations are within the scope of the present invention.

1. A solid-liquid reaction process comprising the steps of:
a) forming a slurry of a solid and a solution containing a species (SA) reactive with the solid and convertible to a species in the gas phase (SG);
b) conducting a reaction between said solid and said species SA in said slurry in a vessel to produce a valuable commodity; and
c) controlling a process condition of said slurry to minimise reactive conversion of said species SA to said species SG;
wherein reactive conversion of species SA to said species SG in said vessel is minimised and build up of concentration of species SG, by evolution from the slurry prevented or minimized by placement of a laminar slurry cover buoyant with respect to said slurry in said vessel.

2. The process according to claim 1 wherein at least one of species SA and species SG are inorganic, species SA being a leaching reagent.

3. The process according to clam 2 comprising the steps of:
a) forming a slurry of a gold containing ore and an alkaline solution containing aqueous cyanide reactive with the gold bearing ore and convertible to hydrogen cyanide in the gas phase;
b) conducting a cyanidation reaction between the gold bearing ore and aqueous cyanide in said slurry in a vessel forming part of a leach plant; and
c) controlling at least pH of said slurry to minimise reactive conversion of aqueous cyanide to hydrogen cyanide in the gas phase, the placement of said laminar slurry cover minimising reactive conversion of aqueous cyanide to hydrogen cyanide in the gas phase.

4. The process according to claim 1 wherein said slurry in said vessel is agitated.

5. The process according to claim 4 wherein said laminar cover is secured to said vessel superstructure by securing means to prevent rotation of said cover.

6. The process according to claim 3 wherein placement of said laminar slurry cover is conducted under cold climate conditions and low pressure climatic conditions.

7. The process according to claim 1 wherein said vessel is a tank with circular cross-section and said slurry cover is divided into segments of said circular cross-section.

8. The process according to claim 3 wherein said cyanidation reaction is conducted in a plurality of vessels, at least one of the vessels being fitted with said slurry cover.

9. The process according to claim 1 wherein said slurry cover covers the near totality of a surface area of said vessel.

10. The process according to claim 1 wherein said slurry cover covers the totality of a surface area of said vessel.

11. The process according to claim 9 wherein said cover is UV and abrasion resistant.

12. The process according to claim 4 wherein said solution contains hypersaline water.

13. The process according to claim 4 wherein a thickness of said cover is selected with reference to degree of agitation of said slurry in use.

14. A vessel when used in the process according to claim 1.

15. A leach circuit including at least one vessel as claimed in claim 14.
